(19) United States
(12) Patent Application Publication
(10) Pub. No.: US 2013/0251125 A1
(43) Pub. Date: Sep. 26, 2013

(54) MANAGING MULTIPLE PASSCODES RELATED TO A SINGLE CALL-IN NUMBER USED BY A PHONE DEVICE

(71) Applicants: Lisa Seacat DeLuca, San Francisco, CA (US); Soobaek Jang, Hamden, CT (US)

(72) Inventors: Lisa Seacat DeLuca, San Francisco, CA (US); Soobaek Jang, Hamden, CT (US)

(73) Assignee: INTERNATIONAL BUSINESS MACHINES CORPORATION, Armonk, NY (US)

(21) Appl. No.: 13/426,413

(22) Filed: Mar. 21, 2012

(51) Int. Cl. H04M 11/00

(52) U.S. Cl. 379/93.02

(57) ABSTRACT

An embodiment of the invention is used with a conference calling system that includes a plurality of client phones, and a conference call center. Passcodes are entered into a list contained in a given client phone, wherein all listed passcodes are associated with a specified phone number that can be used to establish a connection between the given client phone and the conference call center. The specified phone number is used at the given client phone to access the passcode list. A passcode is selected from the list for transmission from the given client phone to the conference call center, over the phone connection established using the specified phone number. In response to receiving the selected passcode at the conference call center, the conference call center is operated to connect the given client phone into a conference call with one or more other client phones.

### BACKGROUND

1. Field

The invention disclosed and claimed herein generally pertains to a method and apparatus for using a phone device, including a wireless mobile phone or smart phone, to readily access a conference call-in phone number and one of multiple passcodes related to such number. More particularly, the invention pertains to a method and apparatus of the above type, wherein the multiple passcodes are each stored on the phone device, or alternatively are each made available to the phone device from a call-in conference call center or the like.

2. Description of the Related Art

There is increasing use of conference call centers or systems, wherein multiple conferees can each call into a conference center from different locations. Typically, the conferees include a moderator and one or more participants. Each conferee uses a call-in phone number to connect with the conference center, and then sends a passcode or like identifier to the center, for validation or verification. In response to receiving a proper passcode from a given conference phone, the conference center connects that phone into a related conference call.

In conferencing systems of the above type, it may be necessary for certain system users to keep track of multiple passcodes, pin numbers, or like identifiers that all pertain to a single conference call-in number. As an example, conference calls usually require that one of the intended conferees must be pre-designated as the moderator, who will have certain responsibilities for the conference. One such responsibility could be to have available a complete record of the passcodes of each of the conference participants. The moderator is thus able to be a vital information source for other conferees, such as participants who never received passcodes, or who have forgotten what they were.

In addition, persons such as section or department managers may need to have information readily available that pertains to multiple conference call-in phone numbers, wherein each call-in number has its own list of passcodes or pin numbers. Such information, collectively, could be quite extensive. At the same time, in an environment in which portable phone devices are used extensively, it is very common for someone to need information for a conference call, at a time when they are far from any office support or the like.

### SUMMARY

Embodiments of the invention provide a method, apparatus, and computer program product for storing information pertaining to a conference call-in phone number on devices that may include mobile phones, smart phones, and other portable devices. The information can comprise a list of passcodes or pin numbers associated with the call-in phone number, wherein the call-in phone number is used to readily display or access the list. In a method comprising an embodiment of the invention, the method is used with a conference calling system that includes a plurality of client phones, and also a conference call center having a server. The method includes entering each of a plurality of passcodes into a list contained in a given client phone, wherein all of the passcodes entered into the list are associated with a specified phone number that can be used to establish a phone connection between the given client phone and the call center. The method further includes using the specified phone number at the given client phone to selectively access the list of passcodes. One of the passcodes of the accessed list is selected for transmission from the given client phone to the conference call center, over a phone connection established between the given client phone and the conference call center by using the specified phone number. In response to receiving the selected passcode at the conference call center, the call center is operated to connect the given client phone into a conference call with one or more other client phones.

### BRIEF DESCRIPTION OF THE SEVERAL VIEWS OF THE DRAWINGS

FIG. 1 is a block diagram showing components for use with embodiments of the invention.

FIG. 2 is a schematic diagram showing an illustrative phone device that may be used in embodiments of the invention.

FIG. 3 is a schematic diagram showing the phone device of FIG. 2 adapted for use in one embodiment of the invention.

FIG. 4 is a schematic diagram showing the phone device of FIG. 2 adapted for use in another embodiment of the invention.

FIGS. 5 and 6 are flowcharts pertaining to the embodiments of FIGS. 3 and 4, respectively.

FIG. 7 is a flowchart showing steps of a method comprising a further embodiment of the invention.

FIG. 8 is a block diagram showing a computer or data processing system that may be used in implementing one or more components of embodiments of the invention.

### DETAILED DESCRIPTION

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “circuit,” “module,” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

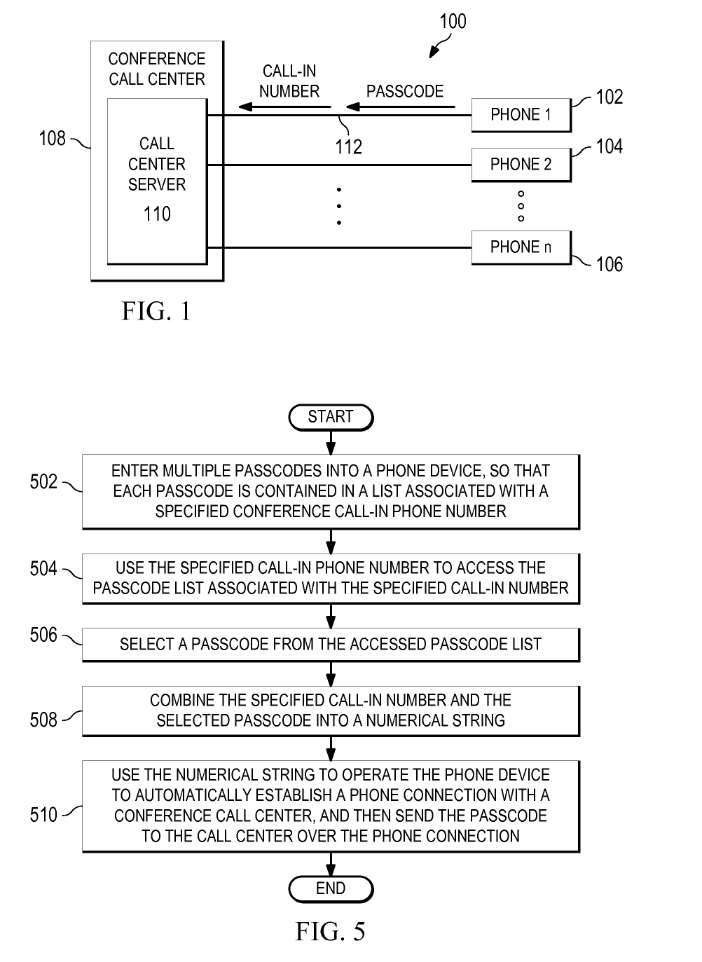

Referring to FIG. 1, there is shown a conference calling system 100, in which embodiments of the invention may be used or practiced. System 100 includes phones 1-n, also referenced as phones 102-106, respectively. System 100 additionally includes a conference call center 108, which comprises a call center server 110, and may further comprise other conventional components which are not shown.

When one of the phones such as phone 102 calls into conference call center 108 with a proper call-in phone number, a phone connection 112 is established between phone 102 and conference call center 108. A passcode is then sent over connection 112 from the connected phone to the call center, in response to a call center request. The passcode is thus sent as a sequence or series of audible tones that represent respective characters of the passcode. Call center server 110 uses the passcode to verify the phone 102, and then connects phone 102 into a conference call with one or more other phones that are similarly connected to conference call center 108.

As described above, a user of a conference calling system such as conference calling system 100 may need to keep track of a substantial number of passcodes or pin numbers, and be able to readily access or use them. As a further example of this need, it is generally a rule that a call-in phone conference cannot begin until a moderator has been connected into the conference. Another common rule is that the conference can have only one moderator. However, it is desirable to avoid a situation in which a number of participants, who have already signed into a phone conference, are kept waiting for a moderator who is delayed for some reason. Accordingly, it is common practice to authorize two or more participants to each be able to serve as moderator. When one of these authorized participants signs into the conference, he will sign in as conference moderator, if no one else has yet signed in for the moderator role. However, if someone else has already signed in as moderator, the authorized participant will sign in only as a participant. In order to accomplish this, each of the authorized participants is given at least two different passcodes, one for signing in as moderator, and the other for signing in as a conference participant.

In addition, a moderator may want to maintain a list of the passcodes of particular individuals, so that he will be able to specifically identify certain persons in a conference from their respective passcodes.

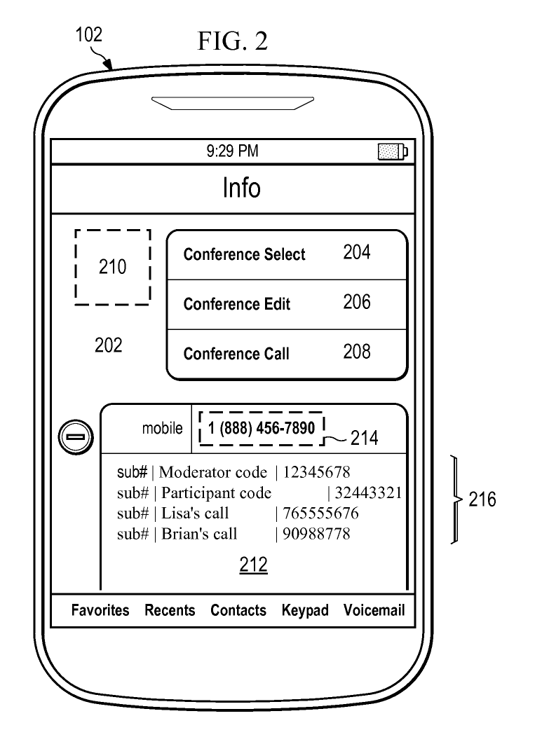

Referring to FIG. 2, there is shown a phone associated with conference calling system 100, such as phone 102, which has been adapted to illustrate certain features of embodiments of the invention. More particularly, phone 102 has been configured to enable a user of such phone to more easily manage multiple passcodes, which are all associated with a single call-in phone number used for conferencing. In response to operation of a control element of phone 102, such as a keypad or a favorites or other button, a screen 202 of phone 102 displays three buttons or selection elements 204-208, which each pertain to phone conferencing.

By means of an element such as conference select button 204, a user can direct phone 102 to display a window 212, which has a location for entering a given conference call-in phone number 214. After entering the given call-in phone number, the user can also enter one or more subsequence numbers that are all associated with the given call-in number, into a list 216 that is likewise displayed on window 212. Thus, each subsequence number is stored in phone 102, together with call-in number 214. Each subsequence number in the list 216 is a passcode, pin number, or like identifier that could be used by the user of phone 102, or by someone else who is related to a phone conference that can be accessed by call-in phone number 214. It is to be emphasized that list 216 shows four subsequence numbers only by way of example, and for purposes of illustration. Accordingly, such list could include substantially more or different subsequence numbers.

For convenience, the terms “subsequence number” and “passcode” are used herein as synonyms of each other, and are both intended to have the same meaning. As used herein, both of these terms mean, or refer to, a pin number, numerical identifier, or other string or sequence of numbers that is used to verify, validate, or authenticate a phone call or phone user that is seeking to establish a connection with a conference call center as described herein.

In embodiments of the invention, it is anticipated that a number of different conference call-in phone numbers 214 could be stored in phone 102, each with its associated list 216 of passcodes or subsequence numbers. Phone 102 is further configured to enable a user to quickly scroll through multiple call-in numbers, by operation of conference select button 204. For example, each time conference select button 204 is pressed or operated, a different one of the call-in numbers, along with its associated list 216, would appear on window 212.

When a given call-in phone number is displayed on window 212, the conference edit button 206 can be used to select a particular subsequence number or passcode of the displayed list for editing. Thus, the selected subsequence number or passcode could be modified or deleted. The conference edit button 206 could also be used to add a new subsequence number to the list.

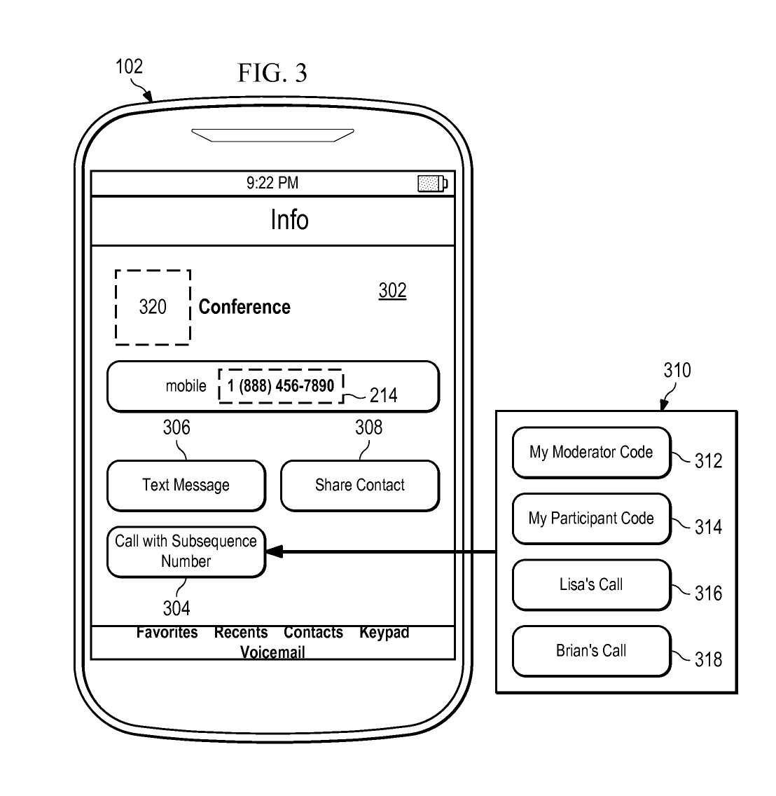

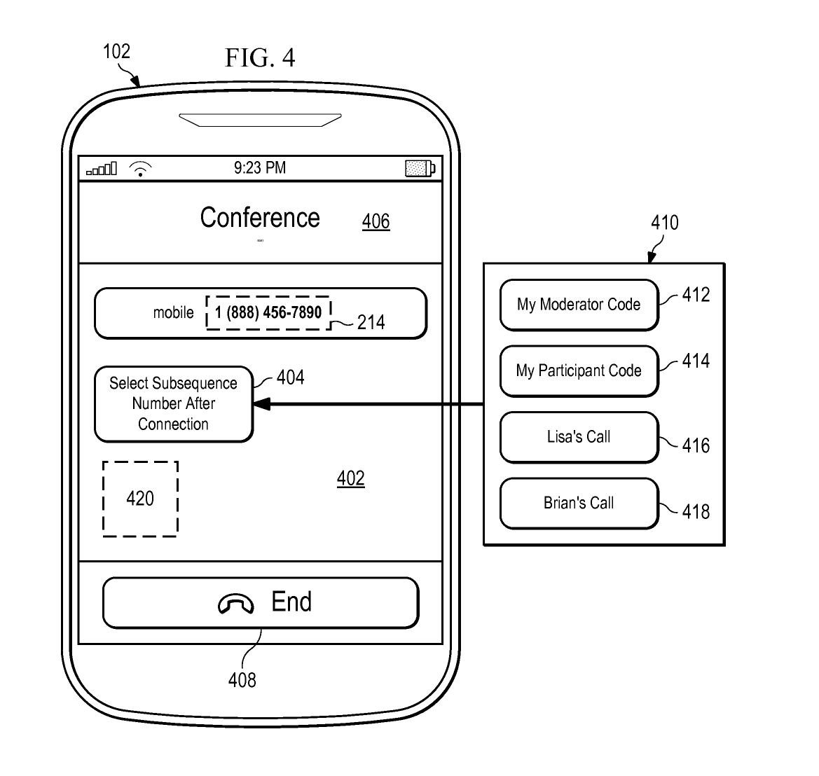

Referring further to FIG. 2, when call-in phone number 214 has been specified or selected for display on window 212, the conference call button 208 can be used to initiate a process of connecting phone 102 into a conference call. Such process uses the specified call-in number, and also a passcode selected from the associated list 216. Two alternative embodiments of the invention for carrying out this process are described hereinafter, in connection with FIG. 3 and FIG. 4, respectively.

FIG. 2 further shows a processor component 210 included in phone 102. Processor component 210 comprises software and/or hardware elements for use in carrying out the respective tasks discussed above in connection with FIG. 2. Also, while FIG. 2 shows three buttons 204-208 that are associated with conferencing, this has been done primarily for purposes of illustration. Other embodiments of the invention could use fewer buttons, or different configurations of buttons or control elements, to perform the respective tasks for which buttons 204-208 are provided.

Referring to FIG. 3, there is shown an embodiment of the invention wherein phone 102 displays a screen 302, in response to operation of conference call button 208 to initiate a conference call using the specified call-in number, as described above in connection with FIG. 2. Screen 302 includes call-in phone number 214, and further includes buttons or other selection elements 304-308. The button 304 is identified as being for use to call with a subsequence number.

When button 304 is operated, a list 310 is displayed on screen 302. List 310 comprises buttons or selection elements 312-318, which each correspond to a different one of the subsequence numbers or passcodes of list 216. Accordingly, each of the buttons 312-318 is related to the displayed call-in phone number 214 that was specified by using conference select button 204 of FIG. 2. Usefully, instead of the numerical passcodes of list 216, each of the buttons of list 310 depicts a brief textual description of the passcode to which it corresponds. For example, button 312 shows the description “My Moderator Code”, rather than the corresponding passcode “12345678” of list 216. It is anticipated that such descriptions will be much easier for a user to remember and respond to, than a string of numbers.

After using button 304 to display list 310 of subsequence numbers, the user determines which of buttons 312-318 represents the passcode that he intends to use to enter a particular phone conference. For example, the user could intend to use the moderator code of list 216 for the conference, which corresponds to button 312 of list 310 shown in FIG. 3. Accordingly, the user presses button 312.

In response, phone 102 is operated to call into conference call center 108 or the like, wherein the call uses both call-in phone number 214 and the moderator passcode selected by means of button 312. This operation is described below in further detail. Moreover, after using button 312 to select the passcode, the user does not need to take any more action or do anything further, until after the conference call has been established. Thus, the embodiment of FIG. 3 provides a “one touch” call-in system.

After a user has selected one of the subsequence numbers of list 310 for a particular conference, phone 102 is operable to combine the selected number with call-in phone number 214. Thus, if the selected number is the passcode of button 312, phone 102 would initially form the numerical string 1-888-456-7890x12345678. Phone 102 would then carry out an automatic procedure, wherein call-in phone number 214 is used to set up a phone connection with conference call center 108, while the passcode is retained in memory or the like. Thereafter, in response to a request from conference call center 108 for a passcode, phone 102 is automatically operated to send the retained passcode to conference call center 108, and phone 102 is connected into the particular conference.

As additional options, screen 302 includes a text message button 306 and a share contact button 308, which may also be used in conference related activities.

Referring further to FIG. 3, there is shown a processor component 320 included in phone 102 which comprises software and/or hardware elements. Processor component 320 is configured to interact with other components of phone 102, in order to carry out the respective tasks discussed above in connection with FIG. 3.

Referring to FIG. 4, there is shown an embodiment of the invention which is provided by using phone 102, wherein the phone is modified from the embodiment of FIG. 2. More specifically, phone 102 is modified so that conference call button 208 is not used to generate screen 302 of FIG. 3. Instead, operation of button 208 of FIG. 2 causes phone 102 to display a screen 402 as shown by FIG. 4. Screen 402 includes the specified call-in phone number 214, and further includes a button or other selection element 404. Button 404 is identified as being for use to select a subsequence number, after a conference phone connection has been established.

FIG. 4 further shows that a conference call has been established between phone 102 and conference call center 108 or the like. This is indicated by the conference display element 406, and also by the displayed button 408, which may be used to end the conference phone call. In one mode, the conference call could have been set up automatically by phone 102, in response to a user of phone 102 pressing conference call button 208 shown in FIG. 2. In this mode, phone 102 would be configured to dial call-in phone number 214 in response to operation of button 208, so that a phone connection would be established with the conference call center 108. Alternatively, a user of phone 102 could set up the phone connection manually, by dialing in call-in phone number 214.

After the conference call connection has been set up, the call center will ask the user of phone 102 to provide a verifying passcode, as described above. In response, and while the established phone connection is continuing, the user operates button 404 of FIG. 4, which causes phone 102 to display a list 410 on screen 402. List 410 comprises buttons or selection elements 412-418, and for purposes of illustration is shown to be substantially identical to list 310 of FIG. 3. Accordingly, each of buttons 412-418 corresponds to a different one of the passcodes of list 216 of FIG. 2, and is related to call-in phone number 214. Moreover, each of the buttons of list 410 shows a textual description of the passcode to which it corresponds.

By displaying list 410 to a user of phone 102, the user is able to readily select a passcode in response to a passcode request received from the call center. For example, if the user intends to select the moderator code, he would just press button 412. Phone 102 would then send the corresponding passcode to conference call center 108, over the previously established phone connection. Thus, it would not be necessary for the user to remember a string or sequence of numbers comprising the passcode, or to enter a string of numbers manually.

Referring further to FIG. 4, there is shown a processor component 420 included in phone 102, which comprises software and/or hardware elements. Processor component 420 is configured to interact with other components of phone 102 to carry out the respective tasks discussed above in connection with FIG. 4.

Referring to FIG. 5, there is shown a flowchart depicting steps for a method comprising an embodiment of the invention. At step 502, multiple passcodes are entered into a phone device, so that each passcode is contained in a list associated with a specified conference call-in phone number. This step could be implemented by means of phone 102, as described above in connection with FIG. 2. Steps 504 and 506 use the specified call-in phone number to access the passcode list associated with the specified call-in number, and then select the passcode from the accessed passcode list. These steps could be carried out by operating button 204 of FIG. 2 to select a specified call-in phone number, and using button 304 of FIG. 3 to access the list of passcodes pertaining to that call-in number. A passcode could then be selected from the list, by using one of buttons 312-318.

At steps 508 and 510, the specified call-in number and selected passcode are combined into a numerical string, which is used to operate the phone device to automatically establish a phone connection with a conference call center, and then send the passcode to the call center over the phone connection. These steps may be carried out by operating phone 102 in a “one touch” conference call-in mode, as described above in connection with FIG. 3.

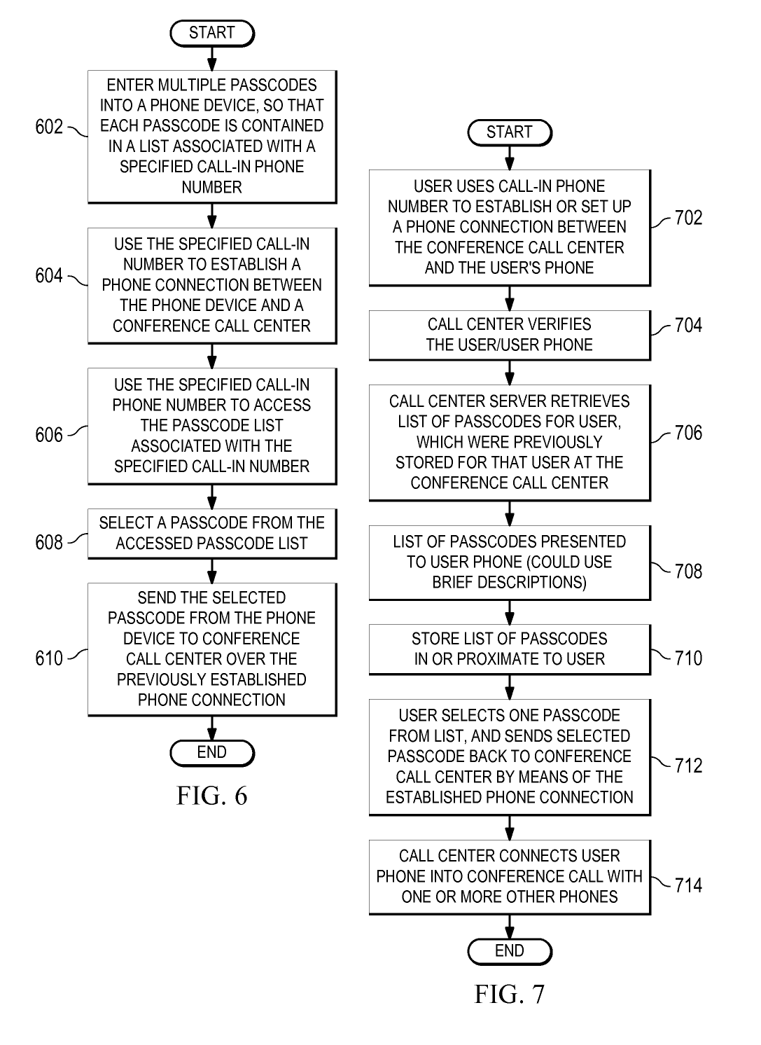

Referring to FIG. 6, there is shown a flowchart depicting steps for a method comprising a further embodiment of the invention. At step 602, multiple passcodes are entered into a phone device, so that each passcode is contained in a list associated with a specified conference call-in phone number. This step could be implemented by means of phone 102, as described above in connection with FIG. 2. Step 604 uses the specified call-in number to establish a phone connection between the phone device and a conference call center. This could be done manually, or by operating phone 102 in an automatic mode.

Steps 606 and 608 use the specified call-in phone number to access the passcode list associated with the specified call-in number, and then select a passcode from the accessed passcode list. These steps could be carried out by operating button 204 of FIG. 2 to select a specified call-in phone number, and using button 404 of FIG. 4 to access the list of passcodes pertaining to that call-in number. A passcode could then be selected from the list, by using one of buttons 412-418.

At step 610, the selected passcode is sent from the phone to the conference call center over the previously established phone connection.

Referring to FIG. 7, there is shown a flowchart depicting steps for a method comprising an embodiment of the invention. In this method, conference call center 108 and its server 110 play a further role in connecting a phone such as phone 102 into a conference call with one or more other phones. More particularly, at step 702 a user of phone 102 uses a call-in phone number, e.g. 1-888-456-7890, to establish phone connection 112 between conference call center 108 and phone 102, as described above. At step 704, a procedure is carried out to verify the user of phone 102. For example, after the connection 112 has been set up, the user of phone 102 could send a login sequence of numbers over the phone connection, wherein the user was previously provided with the log in sequence. Alternatively, call center 108 could prompt the user of phone 102 to furnish a login passcode, which the user would then send over the phone.

After the user of phone 102 has been verified, server 110 at step 706 retrieves a list of passcodes for the user from call center storage. The list may, for example, have been developed and stored at the call center as the result of prior interaction between the user of phone 102 and call center 108. The retrieved list is exemplified by the list 216 described above, but is by no means limited thereto. At step 708, the list of passcodes is presented to the user of phone 102, by sending information representing each passcode over phone connection 112. At step 710, the list is stored within, or proximate to the user of phone 102.

It is anticipated that the list and respective passcodes thereof could be presented to the user of phone 102 in a number of different forms. One such form, as represented by list 216, would explicitly show each of a number of passcodes, and could be entered into the memory of phone 102.

As an alternative presentation, each passcode on the list could be sent from the conference call center 108 to phone 102 in the form of representative metadata, which would be displayed on phone 102. Such metadata is exemplified by list 310 of FIG. 3, and list 410 of FIG. 4. As described above, each of these lists represent each passcode of list 216 with a brief unique textual description or statement, such as “My Moderator Code” for passcode 12345678. Upon seeing a description of this type on the phone display, which represents the passcode that the user wants to use in a phone conference, the user could select such description in accordance with step 712. The selected description or metadata would then be sent back to the conference call center, over the established phone connection 112, and the call center would determine the correct password from the selected description.

As a further form of presenting passcodes to the user phone at step 708, conference call center 108 could send representative metadata or descriptions of the above type to the user phone in the form of audible synthesized speech. Moreover, the metadata for each passcode could be accompanied by a selection instruction. Thus, conference call center 108 would sequentially send spoken messages to phone 102 over phone connection 112 such as “Press 1 to use ‘My Moderator Code’”, and “Press 2 to use ‘My Participant Code’”. In one mode, upon hearing the message for the passcode that he intended to use, the user of phone 102 would press the number key of the keypad specified for that message. Such number would then be sent back to the conference center, to select the proper passcode in accordance with step 712. In another mode, the user of phone 102 could select the proper passcode, in accordance with step 712, by audibly speaking a description of the passcode into the phone, such as “My Moderator Code” or “My Participant Code”.

It is to be noted that in above embodiments wherein passcode descriptions or metadata are transferred between the call center and phone 102 over connection 112, it would not be necessary for the phone user to know the actual passcode involved, that is, the respective numerical sequences thereof.

In yet other embodiments of the invention, the passcode list could be sent to phone 102 by means such as e-mail, text messages, or instant messages.

At step 714, the call center 108 recognizes the passcode, and connects the user phone 102 into a conference call with one or more other phones. If a new passcode is entered, the system could prompt the user to save the passcode, and optional tags may be associated with the saved passcodes.

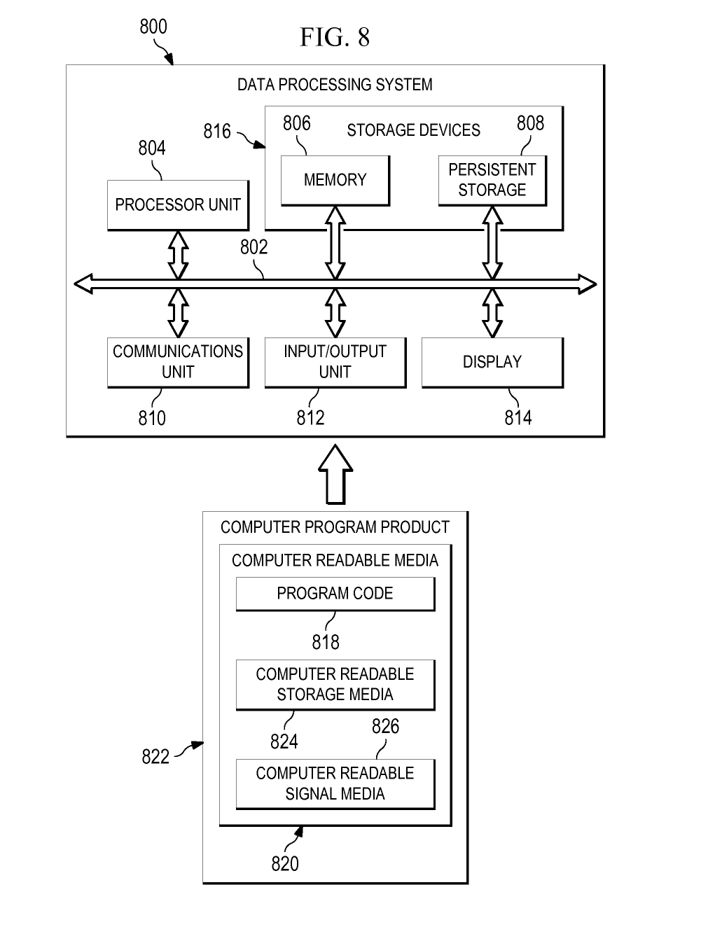

FIG. 8 depicts a block diagram of a data processing system in accordance with an illustrative embodiment. Data processing system 800 is an example of a computer, which may be used to implement one or more components of embodiments of the invention, and in which computer usable program code or instructions implementing the processes may be located for the illustrative embodiments. In this illustrative example, data processing system 800 includes communications fabric 802, which provides communications between processor unit 804, memory 806, persistent storage 808, communications unit 810, input/output (I/O) unit 812, and display 814.

Processor unit 804 serves to execute instructions for software that may be loaded into memory 806. Processor unit 804 may be a set of one or more processors or may be a multi-processor core, depending on the particular implementation. Further, processor unit 804 may be implemented using one or more heterogeneous processor systems, in which a main processor is present with secondary processors on a single chip. As another illustrative example, processor unit 804 may be a symmetric multi-processor system containing multiple processors of the same type.

Memory 806 and persistent storage 808 are examples of storage devices 816. A storage device is any piece of hardware that is capable of storing information, such as, for example, without limitation, data, program code in functional form, and/or other suitable information either on a temporary basis and/or a permanent basis. Memory 806, in these examples, may be, for example, a random access memory, or any other suitable volatile or non-volatile storage device. Persistent storage 808 may take various forms, depending on the particular implementation. For example, persistent storage 808 may contain one or more components or devices. For example, persistent storage 808 may be a hard drive, a flash memory, a rewritable optical disk, a rewritable magnetic tape, or some combination of the above. The media used by persistent storage 808 may be removable. For example, a removable hard drive may be used for persistent storage 808.

Communications unit 810, in these examples, provides for communication with other data processing systems or devices. In these examples, communications unit 810 is a network interface card. Communications unit 810 may provide communications through the use of either or both physical and wireless communications links.

Input/output unit 812 allows for the input and output of data with other devices that may be connected to data processing system 800. For example, input/output unit 812 may provide a connection for user input through a keyboard, a mouse, and/or some other suitable input device. Further, input/output unit 812 may send output to a printer. Display 814 provides a mechanism to display information to a user.

Instructions for the operating system, applications, and/or programs may be located in storage devices 816, which are in communication with processor unit 804 through communications fabric 802. In these illustrative examples, the instructions are in a functional form on persistent storage 808. These instructions may be loaded into memory 806 for execution by processor unit 804. The processes of the different embodiments may be performed by processor unit 804 using computer implemented instructions, which may be located in a memory, such as memory 806.

These instructions are referred to as program code, computer usable program code, or computer readable program code that may be read and executed by a processor in processor unit 804. The program code, in the different embodiments, may be embodied on different physical or computer readable storage media, such as memory 806 or persistent storage 808.

Program code 818 is located in a functional form on computer readable media 820 that is selectively removable and may be loaded onto or transferred to data processing system 800 for execution by processor unit 804. Program code 818 and computer readable media 820 form computer program product 822. In one example, computer readable media 820 may be computer readable storage media 824 or computer readable signal media 826. Computer readable storage media 824 may include, for example, an optical or magnetic disc that is inserted or placed into a drive or other device that is part of persistent storage 808 for transfer onto a storage device, such as a hard drive, that is part of persistent storage 808. Computer readable storage media 824 also may take the form of a persistent storage, such as a hard drive, a thumb drive, or a flash memory that is connected to data processing system 800. In some instances, computer readable storage media 824 may not be removable from data processing system 800.

Alternatively, program code 818 may be transferred to data processing system 800 using computer readable signal media 826. Computer readable signal media 826 may be, for example, a propagated data signal containing program code 818. For example, computer readable signal media 826 may be an electromagnetic signal, an optical signal, and/or any other suitable type of signal. These signals may be transmitted over communications links, such as wireless communication links, an optical fiber cable, a coaxial cable, a wire, and/or any other suitable type of communications link. In other words, the communications link and/or the connection may be physical or wireless in the illustrative examples. The computer readable media also may take the form of non-tangible media, such as communications links or wireless transmissions containing the program code.

In some illustrative embodiments, program code 818 may be downloaded over a network to persistent storage 808 from another device or data processing system through computer readable signal media 826 for use within data processing system 800. For instance, program code stored in a computer readable storage media in a server data processing system may be downloaded over a network from the server to data processing system 800. The data processing system providing program code 818 may be a server computer, a client computer, or some other device capable of storing and transmitting program code 818.

The different components illustrated for data processing system 800 are not meant to provide physical or architectural limitations to the manner in which different embodiments may be implemented. The different illustrative embodiments may be implemented in a data processing system including components in addition to and/or in place of those illustrated for data processing system 800. Other components shown in FIG. 8 can be varied from the illustrative examples shown. The different embodiments may be implemented using any hardware device or system capable of executing program code. As one example, data processing system 800 may include organic components integrated with inorganic components and/or may be comprised entirely of organic components excluding a human being. For example, a storage device may be comprised of an organic semiconductor.

As another example, a storage device in data processing system 800 is any hardware apparatus that may store data. Memory 806, persistent storage 808, and computer readable media 820 are examples of storage devices in a tangible form.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

The flowcharts and block diagrams in the figures illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

What is claimed is:

1. A method for use with a conference calling system that includes a plurality of client phones and also a conference call center having a server, said method comprising the steps of:
entering each of a plurality of passcodes into a list contained in a given client phone, wherein all of the passcodes entered into said list are associated with a specified phone number that can be used to establish a phone connection between the given client phone and the conference call center;
using the specified phone number at the given client phone to selectively access said list of passcodes;
selecting one of the passcodes of said accessed list for transmission from the given client phone to the conference call center, over the phone connection established between the given client phone and the conference call center by using the specified phone number; and
responsive to receiving the selected passcode at the conference call center, operating the conference call center to connect the given client phone into a conference call with one or more other client phones.

2. The method of claim 1, wherein:
the specified phone number and the selected passcode are combined into a numerical sequence by the given client phone, and are then used sequentially, wherein the specified phone number is used to establish said phone connection, and thereafter the given client phone sends the selected passcode over the established connection to the conference call center.

3. The method of claim 2, wherein:
the given client phone is provided with a selection element that is operable by a user, wherein a single operation of the selection element by the user causes the given client phone to form said numerical sequence, and to then sequentially use the specified phone number and the selected passcode to send the selected passcode to the call center, without any further action by the user.

4. The method of claim 1, wherein:
after using the specified phone number to establish the phone connection between the given client phone and the conference call center, and while said phone connection is continuing, operating the given client to access the list of passcodes, and to then select said one of the passcodes for transmission to the conference call center.

5. The method of claim 4, wherein:
the selected passcode comprises a sequence of characters, and is transmitted over the established phone connection to the conference call center by means of audible tones that respectively represent each of the characters.

6. The method of claim 1, wherein:
multiple call-in phone numbers are stored in the given client phone, wherein each call-in phone number can be used to establish the phone connection between the given client phone and the conference call center, and each of the call-in phone numbers has an associated list stored in the given client phone that includes one or more passcodes.

7. The method of claim 1, wherein:
each passcode in the list is uniquely represented by specified metadata.

8. The method of claim 1, wherein:
said entering step includes receiving information representing each of one or more passcodes at the given client phone, wherein the received passcode information is sent over the established phone connection from the call center server.

9. The method of claim 8, wherein:
the information received for each passcode includes a numerical digit, and a user of the given client phone can select a given passcode by using a keypad of the given client phone to select the numerical digit of the given passcode, for transmission to the conference call center over the phone connection.

10. The method of claim 8, wherein:
the information representing each passcode is sent to the given client phone in the form of audible speech.

11. The method of claim 8, wherein:
a user of the given client phone transmits a selected passcode to the conference call center, by means of a message comprising audible speech that enables the call center server to uniquely identify the selected passcode.

12. The method of claim 8, wherein:
each passcode comprises a particular sequence of alphanumeric characters, and none of said sequences are communicated from the conference call center to the given client phone.

13. A computer program product in a computer recordable storage medium for use with a conference calling system that includes a plurality of client phones and also a conference call center having a server, said computer program product comprising:
instructions for entering each of a plurality of passcodes into a list contained in a given client phone, wherein all of the passcodes entered into said list are associated with a specified phone number that can be used to establish a phone connection between the given client phone and the conference call center;
instructions for using the specified phone number at the given client phone to selectively access said list of passcodes;
instructions for selecting one of the passcodes of said accessed list for transmission from the given client phone to the conference call center, over a phone connection established between the given client phone and the conference call center by using the specified phone number; and
instructions responsive to receiving the selected passcode at the conference call center, for operating the conference call center to connect the given client phone into a conference call with one or more other client phones.

14. The computer program product of claim 13, wherein:
the specified phone number and the selected passcode are combined into a numerical sequence by the given client phone, and are then used sequentially, wherein the specified phone number is used to establish said phone connection, and thereafter the given client phone sends the selected passcode over the established phone connection to the conference call center.

15. The computer program product of claim 14, wherein:
the given client phone is provided with a selection element that is operable by a user, wherein a single operation of the selection element by the user causes the given client phone to form said numerical sequence, and to then sequentially use the specified phone number and the selected passcode to send the selected passcode to the conference call center, without any further action by the user.

16. The computer program product of claim 13, wherein:
after using the specified phone number to establish the phone connection between the given client phone and the conference call center, and while said connection is continuing, operating the given client to access the list of passcodes, and to then select said one of the passcodes for transmission to the conference call center.

17. Apparatus for use with a conference calling system that includes a plurality of client phones and also a conference call center having a server, said apparatus comprising:
processing means for entering each of a plurality of passcodes into a list contained in a given client phone, wherein all of the passcodes entered into said list are associated with a specified phone number that can be used to establish a phone connection between the given client phone and the conference call center;
processing means for using the specified phone number at the given client phone to selectively access said list of passcodes;
processing means for selecting one of the passcodes of said accessed list for transmission from the given client phone to the conference call center, over a phone connection established between the given client phone and the conference call center by using the specified phone number; and
processing means responsive to receiving the selected passcode at the conference call center, for operating the conference call center to connect the given client phone into the conference call with one or more other client phones.

18. The apparatus of claim 17, wherein:
the specified phone number and the selected passcode are combined into a numerical sequence by the given client phone, and are then used sequentially, wherein the specified phone number is used to establish said phone connection, and thereafter the given client phone sends the selected passcode over the established phone connection to the conference call center.

19. The apparatus of claim 18, wherein:
the given client phone is provided with a selection element that is operable by a user, wherein a single operation of the selection element by the user causes the given client phone to form said numerical sequence, and to then sequentially use the specified phone number and the selected passcode to send the selected passcode to the conference call center, without any further action by the user.

20. The apparatus of claim 17, wherein:
after using the specified phone number to establish the phone connection between the given client phone and the conference call center, and while said connection is continuing, operating the given client to access the list of passcodes, and to then select said one of the passcodes for transmission to the conference call center.
